(19) United States
(12) Patent Application Publication
(10) Pub. No.: US 2013/0147602 A1
(43) Pub. Date: Jun. 13, 2013

(54) DETERMINATION OF USER BASED ON ELECTRICAL MEASUREMENT

(71) Applicants: John Toebes, Cary, NC (US); Malachy Patrick Moynihan, San Jose, CA (US)

(72) Inventors: John Toebes, Cary, NC (US); Malachy Patrick Moynihan, San Jose, CA (US)

(73) Assignee: CISCO TECHNOLOGY, INC., San Jose, CA (US)

(21) Appl. No.: 13/323,017

(22) Filed: Dec. 12, 2011

(51) Int. Cl. G06F 7/04

(52) U.S. Cl. 340/5.82

(57) ABSTRACT

In one embodiment, a user is identified based on one or more electrical measurements corresponding to user contact with a device and a comparison of those measurements with stored user data. An indication of the determined user identity is provided to a user, and one or more aspects of the operation of a device or system can be set based on the determined user identity. The user can be presented with an opportunity to provide feedback regarding whether the determined identity is correct. Subsequent determinations for determining user identity can be based at least in part on the user provided feedback.

### TECHNICAL FIELD

The present disclosure relates generally to system detection of user identity using one or more electrical measurements.

### BACKGROUND

User identity, if known, is a useful parameter for many systems and devices. For example, a user's identity can be used to load a set of previously saved user preferences, provide targeted content, provide targeted advertisements, and log system use.

The identity of a user of a given system or device is often presumed from the context of the use. For example, the user of a mobile phone is often presumed to be the owner of the account associated with the mobile phone because mobile phones are usually not shared. Based on this presumption, there is generally a single set of user preferences associated with a mobile phone and any services or applications accessed by the phone. In other instances, e.g., on a shared system or device, user identity can be determined based on the user entering login credentials. For example, a user of a shared computer that supports multiple user accounts can enter his or her username and password to access the computer. Based on the credentials entered, a set of user preferences for the user associated with those credentials can be loaded and the user's identity can also be made available to applications on the computer.

In the cases of some shared system or devices, however, it can be inaccurate, inconvenient, and/or intrusive to either assume a user's identity or to require him or her to enter login credentials.

### BRIEF DESCRIPTION OF THE DRAWINGS

FIG. 1A illustrates a perspective view of an example contact device for use with a user determination system.

FIG. 1B illustrates a top view of an example contact device for use with a user determination system.

FIG. 1C illustrates a bottom view of an example contact device for use with a user determination system.

FIG. 1D illustrates a first side view of an example contact device for use with a user determination system.

FIG. 1E illustrates a second side view of an example contact device for use with a user determination system.

FIG. 2 illustrates an example user determination system implemented in resources of a contact device.

FIG. 3 illustrates an example user determination system implemented in resources of one or both of a network and a contact device.

FIG. 4 illustrates an example user determination system implemented in resources of one, some, or all of a network, a contact device, and an interface device.

FIG. 5 illustrates a number of example environments of a television remote control supporting user determination.

FIG. 6 is a flowchart of an example method for determining user identity.

FIG. 7A illustrates an example user interface screen including an indication of an identified user.

FIG. 7B illustrates an example user interface screen providing a user with the opportunity to indicate a correct user identity.

FIG. 7C illustrates an example user interface screen acknowledging a user indicated identity.

FIG. 7D illustrates an example user interface screen providing a new user with the opportunity to enter a new user name into a user determination system.

FIG. 8 shows a table including example user contact data.

FIG. 9A shows a table including example user contact data from capacitive touch sensors.

FIG. 9B shows a graphical representation of the data of FIG. 9A.

FIG. 10 shows a graphical representation of an example user determination based on comparison of sensed user data to stored user data.

Like reference numbers and designations in the various drawings indicate like elements.

### DESCRIPTION OF EXAMPLE EMBODIMENTS

Overview

In general, one aspect of the subject matter described in this specification can be embodied in a system including a contact device including at least one contact sensor for reading at least one electrical characteristic of user contact with the contact device, one or more processors, and computer readable medium including instructions executable by the one or more processors and upon execution cause the one or more processors to perform operations including determining a user identity based on a comparison of the at least one electrical characteristic to stored user data, providing an indication of the determined user identity, receiving user feedback regarding the determined user identity, and setting an aspect of system operation based on the user feedback.

One aspect of the subject matter described in this specification can be embodied in methods that include the actions of determining a user identity based on a comparison of stored user data to at least one electrical characteristic read at a sensor of a user contact device, providing an indication of the determined user identity, receiving user feedback regarding the determined user identity, and setting an aspect of system operation based on the user feedback.

In general, one aspect of the subject matter described in this specification can be embodied in a system including means for measuring contact, one or more processors, and computer readable medium including instructions executable by the one or more processors and upon execution cause the one or more processors to perform operations including determining a user identity based on a comparison of the at least one electrical characteristic to stored user data, providing an indication of the determined user identity, receiving user feedback regarding the determined user identity, and setting an aspect of system operation based on the user feedback.

The details of one or more embodiments of the subject matter described in this specification are set forth in the accompanying drawings and the description below. Other features, aspects, and advantages of the subject matter will become apparent from the description, the drawings, and the claims.

### Example Embodiments

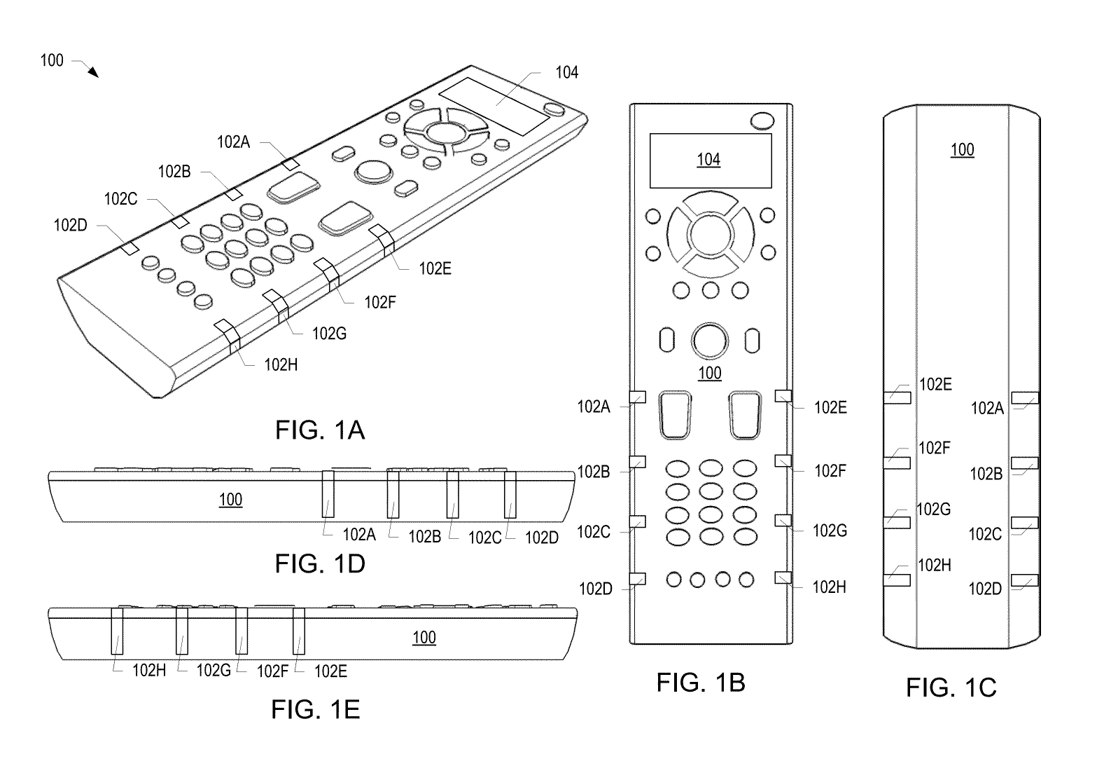

FIGS. 1A-1E illustrate various views of an example contact device 100 for use with a user determination system. FIG. 1A illustrates a perspective view of an example contact device 100 for use with a user determination system. FIG. 1B illustrates a top view of an example contact device 100 for use with a user determination system. FIG. 1C illustrates a bottom view of an example contact device 100 for use with a user determination system. FIG. 1D illustrates a first side view of an example contact device 100 for use with a user determination system. FIG. 1E illustrates a second side view of an example contact device 100 for use with a user determination system.

The example contact device 100 is shown as a remote control (e.g., for a television and/or television set top box). The example of a remote control is provided for purposes of illustration. A contact device for use with a user determination system can include any device in physical contact with a user. Further examples of a contact device include, but are not limited to, a remote control, a video game controller, 3D glasses, a telephone handset, a mobile telephone, a computer mouse, a keyboard, an MP3 player, a laptop computer, a tablet computer, a keychain, a car key, a house key, a kitchen appliance, exercise equipment, scales (e.g., for measuring body weight), and a product scanner (e.g., a handheld barcode or RFID scanner).

The example contact device 100 includes a plurality of sensor contacts 102A-H. The sensors contacts can, for example, be made of a conductive material. In use, one or more impedance characteristics present across at least two of the sensor contacts 102A-H can be measured for use in determining an identity of a user holding the example contact device 100. For example, a galvanic skin response of a user's hand (also resistance or conductance) can be measured between sensor contact 102A and each of sensors 102B-102H. Measurements can also be taken across contact 102B and each of sensors 102C-102H. This can be continued until a measurement has been made across each of possible combinations of sensor contacts. In this example, such measurements would result in 28 values. These can be stored in memory of the contact device 100 and/or transmitted to another device (e.g., a set top box) for determining a user's identity.

In some implementations, measurements can include measurements where two or more contact sensors are read in parallel. For example, a galvanic skin response can be measured across contact 102A and sensors 102E, 102F, 102G, and 102H taken together as a common node.

Although a particular sensor contact configuration is shown, this configuration is provided as an example only. Conductive sensor contacts can be as few as two or as many as can be physically arranged on a contact device. Sensor contacts can vary in size from, for example, that of the head of a push pin to many square inches. For example, a first sensor contact could cover approximately half of the back of a remote control and second sensor contact could cover the other half. Alternatively, for further example, hundreds of relatively small contacts can be distributed across the surface of a remote control.

In some implementations, an example contact device instead includes one or more capacitive sensors. For example, some area of the exterior of a remote control can include capacitive sensors for measuring a capacitance which varies in a manner dependent on a user's hand holding the remote control. In some implementations, a capacitive sensor is formed by a conductive layer lying under an insulating outer shell of a contact device. In some implementations, a voltage or current waveform can be introduced to a circuit including a capacitive sensor and a change in the charging or discharging rate of the capacitive sensor can be measured to determine a change in a capacitance value of the circuit. As with the conductive sensor contacts described above, the arrangement and density of capacitive sensors can be changed without departing from the teachings of the present disclosure. For example, configurations can vary from a single capacitive sensor to thousands of capacitive sensors. The surface area of the capacitive sensors can vary from some portion of the total surface area of the contact device to substantially the entire surface area of the contact device.

In some implementations, a contact device includes a combination of both conductive sensor contacts for measuring galvanic skin response and one or more capacitive sensors. A contact device can include other types of sensors for measuring characteristics of user contact including, but not limited to, pressure transducers, temperature transducers, and accelerometers.

The example contact device 100 can, for example, include a processor, instructions, and memory for polling, measuring, and recording data from the sensor contacts 102A-102H and any capacitive sensors. In some implementations, measurements from the various sensor combinations are taken serially through, for example, multiplexing of one or more processor inputs. Sensors can be sampled in response to some event (for example, the detection of movement using an accelerometer or a remote control keypress). In some implementations, sensors are sampled continuously or periodically, and a large change detected in sensor measurements, indicative of the contact device being grasped, can signal that the current or recently sampled data represents present user contact with the device.

The example contact device 100 includes a display 104. As will be explained below, the display 104 can be used to provide an indication of a determined user identity to a user. In some implementations the display 104 can also be used to present a user with an opportunity to provide feedback regarding the determined user identity. In some implementations, a display is not included as part of the contact device. In such implementations, an indication of a determined user identity can be provided in some other way. For example, an indication can be provided on an external display or as an audible and/or tactile indication, or an indication can be provided through some aspect of the operation of the contact device or a system of which the contact device is a part or with which the contact device is interfaced.

The example contact device 100 can implement all or some of a user determination system as described below.

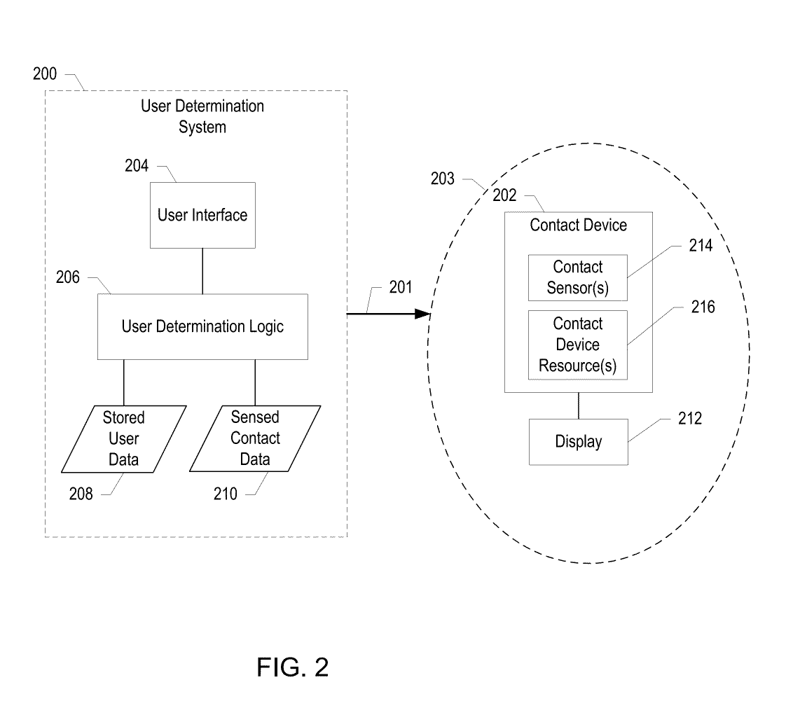

FIGS. 2-4 illustrate example user determination systems implemented in various configurations. In some implementations, a user determination system can implement a passive user identification method. Passive as used here refers to a method that performs the user identification method and sets some aspect of device operation without requiring user input beyond physical contact that the user has made with the device. In some implementations using a passive user identification method, the user determination system can accept user feedback regarding a result of a user determination. This feedback can indicate the accuracy of the user identify determined by the system. For example, the user determination system can indicate a result of a user determination and present the user with the opportunity to indicate that the determined user identity is incorrect, verify that the user identity is correct (or this can be presumed from lack of a user indication that the determination is incorrect), indicate the proper user identity, and/or indicate that the user is a new user that has not previously used the device. In some implementations, user feedback is used to train the user determination system for future analyses.

FIG. 2 illustrates an example user determination system 200 implemented in resources of a contact device 202. The user determination system 200 includes a user interface 204, and user determination logic 206. Contact data as that term is used in this disclosure, includes data corresponding to a user having touched, held, grasped, or otherwise having made physical contact directly (e.g., direct contact with the user's skin) or indirectly (e.g., through gloves or other clothing) with a contact device. The terms “touch” and “contact” will be used throughout to refer generally to any form of user contact with a contact device. Contact data can include, for example, biometric data, and/or any other data related to user contact with a contact device such as, for example, a pressure related to the contact, e.g., strength of a user's grip, size of a user's hand, steadiness of a user's hand, etc. Contact data can include impedance measurements such as conductance and/or resistance measured through a user's skin across two or more conductive sensor contacts as well as capacitance measurements where the proximity of some part of the user's body affects the capacitance of a circuit.

Sensed contact data 210 can include contact data related to present or most recent user contact with a contact device. Stored user data 208 can include stored contact data collected during past user interactions with the user determination system 200 as well as other user data such as stored user identifiers (e.g., user names, or aliases) and corresponding user preferences.

The user determination logic 206 performs one or more analysis operations to identify a user by, for example, comparing sensed contact data 210 with contact data in the stored user data 208 and selecting the user identity in the stored user data that is associated with the stored contact data that is the closest match to the sensed contact data 210. As will be described below, the result of this analysis can be presented to a user through the user interface 204. The user interface 204 is configured to accept feedback from the user regarding whether or not the result of the analysis is accurate. This feedback can then be used to train the user determination logic 206 for use in later analyses.

The example contact device 202 includes one or more contact sensors 214 and additional contact device resources 216. Contact device resources 216 can include, for example, a processor, computer readable memory, and input resources such as, for example, push buttons and/or a touch screen. The contact sensors 214 can include sensors for determining the existence of user contact with the contact device 202, and/or characteristics of human contact with the contact device 202. For example, the contact sensors 214 can include one or more areas of the contact device 202 having one or more of capacitive touch sensors, galvanic skin response sensors, and/or pressure transducers. The contact sensors 214 can, for example, provide output data including biometric data corresponding to a user making contact with the contact device 202.

The contact device 202 can output information to a display 212. Data can be transmitted to the display through wired or wireless methods. In some implementations, the display 212 is external to the contact device as shown in FIG. 2. In some implementations the display 212 is integral to the contact device 202 (e.g., as shown in FIG. 1). The display 212 can include, for example, a monochrome or color LCD display, LED display, an electronic paper display, or any other display technology capable of presenting information in a user perceivable format. The display 212 can be used by the user interface 204 to present information to a user. For example, the result of a user determination analysis can be presented to a user, and/or feedback information can be solicited from a user by the user interface 204 using the display 212.

In some implementations, a display can be replaced or augmented by audio output and/or tactile output. For example, synthesized speech or a tone indicating the results of a user determination analysis can be produced, and tactile output can include a single vibration or a sequence of vibrations. Audio and/or tactile output can be useful, for example, in situations where viewing a display is difficult or impossible, for example, bright environments, environments where a user's sight should be focused elsewhere (e.g., operators of heavy machinery), and implementations designed for users with one or more sensory impairments.

The arrow 201 and the dashed circle 203 around the contact device 202 represent the implementation of the user determination system 200 in resources of the contact device 202. For example, stored user data 208 can be stored in non-volatile computer readable memory of the contact device 202 such as magnetic disk storage or flash memory that are part of the contact device resources 216. Sensed contact data 210 can be read by the contact sensors 214, and, for example, transferred to random access memory of the contact device resources 216. The contact device resources 216 can also include a processor and instructions that cause the processor to perform operations that implement the user determination logic 206 and the user interface 204.

For example, a tablet computer shared among family members that includes a user determination system can set its background wallpaper, or other device settings based on the outcome of the user determination made when the device is picked up by a user. Further examples of device operation that can be set according to a determined user identity include, a mobile telephone setting a contact list, a remote control assigning functions to user programmable buttons, an MP3 player selecting a playlist, and exercise equipment setting parameters according to a favorite exercise routine. In some implementations, the contact device 202 is configured to transmit a determined identity to some other device or system.

In some implementations the contact device, 202 can include a larger integrated device. The contact device can be, for example, machinery or a vehicle occupied by the user. For example, an automobile can include a transducer for measuring the weight of an occupant in the driver's seat of the automobile, and/or one or more sensors on the steering wheel, ignition switch, radio controls, etc. A determined user identity can be used to set user preferences for the automobile or machinery (e.g., radio presets, climate controls, or parameters relating to vehicle performance).

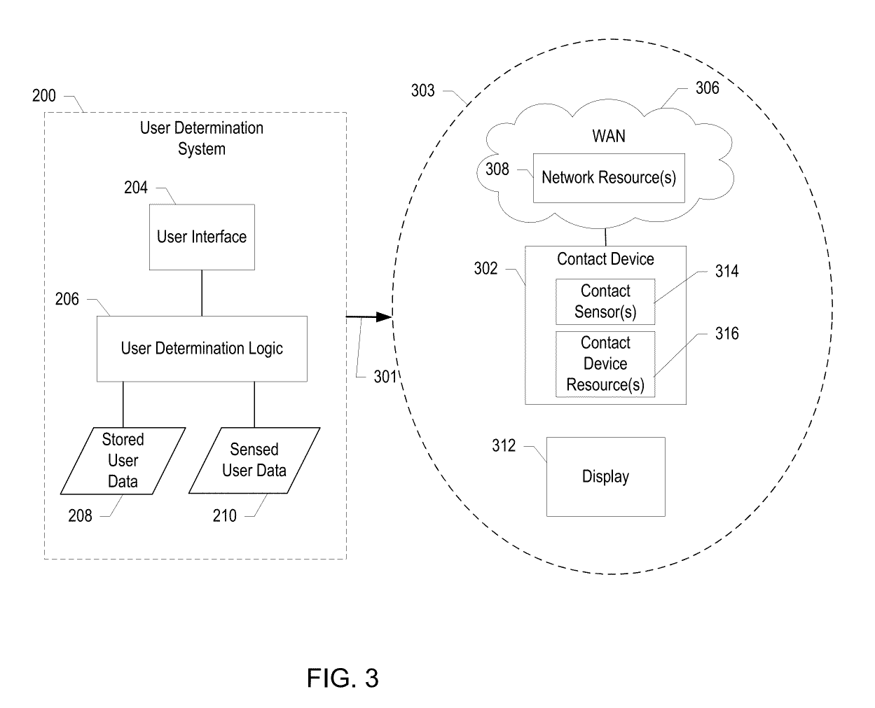

FIG. 3 illustrates the example user determination system 200 implemented in one or both of contact device resources 316 and network resources 308. The contact device 302 includes contact sensors 314 and contact device resources 316. The contact device is able to send data to the wide area network (WAN) 306 which includes one or more network resources 308. In some implementations, the contact device 302 is also able to receive data from the WAN 306. The contact device 302 and/or network resources 308 can output information to a display 312. For example, the display can be connected to or integral to the contact device 302 or the display can be a standalone unit that can receive data for display (e.g., the display 312 can have an associated IP address and data transmitted to that IP address can be shown on the display 312).

The arrow 301 and dashed circle 303 indicate that one or more elements of the user determination system 200 can be implemented in contact device resources 316, in network device resources 308, or in some combination of contact device resources 316 and network device resources 308. For example, the network resources 308 can include processors and/or memory in which any, some, or all of the user interface 204, and user determination logic 206 can be implemented and where stored user data 208 and/or sensed user data 210 can be recorded. Implementing some or all of the user determination system 200 in the network resources 308 can, for example, provide cost, performance, and/or ease of maintenance advantages over implementing some or all of the user determination system 200 in the contact device resources 316.

The contact device 302 can include, for example, a network enabled (e.g., including a wired or wireless Ethernet network connection, a Bluetooth radio, or a cellular radio) remote control, video game controller, telephone handset, mobile telephone, computer mouse, keyboard, MP3 player, laptop computer, tablet computer, keychain, car key, house key, kitchen appliance, exercise equipment, scales (e.g., for measuring body weight), product scanner (e.g., a handheld barcode or RFID scanner), and vehicle.

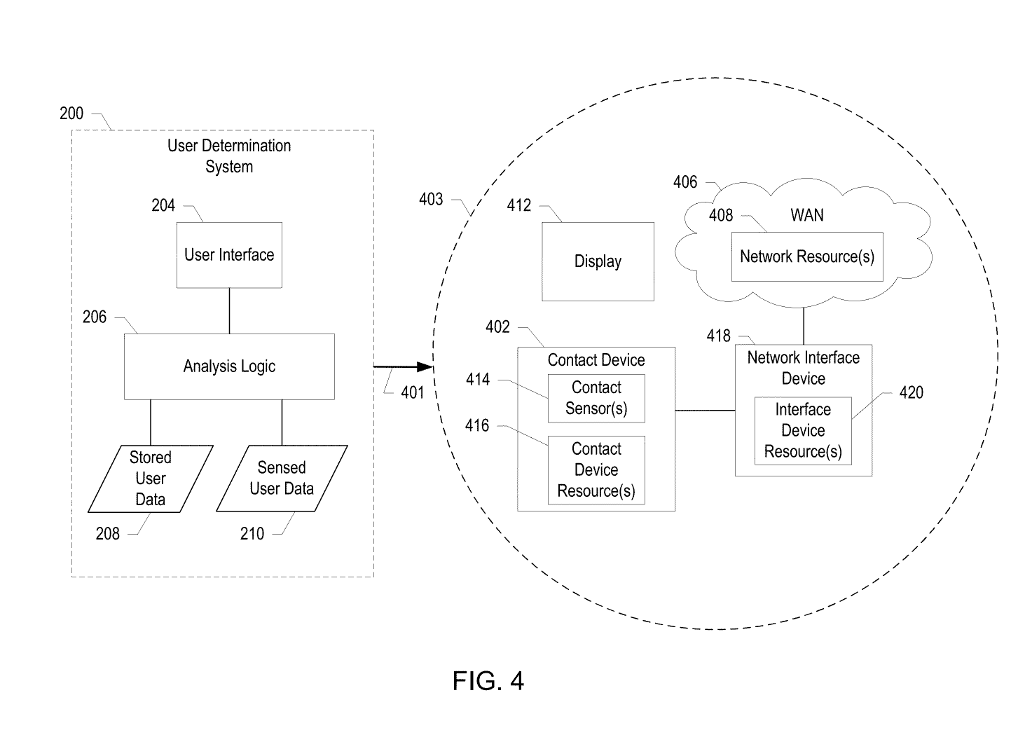

FIG. 4 illustrates an example user determination system 200 implemented in one, some, or all of network interface device resources 420, network resources 408, and contact device resources 416. The contact device 402 includes contact sensors 414 and contact device resources 416. The contact device 402 can send data to a network interface device 418. In some implementations, the network interface device 418 can communicate with the network resources 408 which can be reached over the WAN 406. The contact device 402, network interface device 418, and/or network resources 408 can output information to a display 412. For example, the display 412 can be connected to or integral to the contact device 402, the display 412 can be a monitor connected to the network interface device 418, or the display can be a standalone unit that can receive data for display (e.g., the display 412 can have an associated IP address and data transmitted to that IP address can be shown on the display 412).

The arrow 401 and dashed circle 403 indicate that one or more elements of the user determination system 200 can be implemented in one, some, or all of contact device resources 416, network interface device resources 420, and network resources 408. For example, the network resources 408, network interface device resources 420, and contact device resources 416 can include processors and/or memory in which any, some, or all of the user interface 204, and user determination logic 206 can be implemented and where stored user data 208 and/or sensed user data 210 can be recorded. Implementing some or all of the user determination system 200 in the network resources 408 can for example, provide cost, performance, and/or ease of maintenance advantages over implementing some or all of the user determination system 200 in the contact device resources 416 and/or the network interface device resources 420.

In some implementations, the contact device 402 can include, for example, a remote control for a television or a television set top box. The remote control can, for example, operate a television set top box acting as a network interface device 418 for a cable television network delivering MPEG encoded video for decoding and presentation to a user on the display 412. The contact device 402 can also include, for example, remote controls for other types of equipment, and multipurpose devices (e.g., mobile telephones, MP3 players, table computers, and laptop computers) programmed to operate as remote controls.

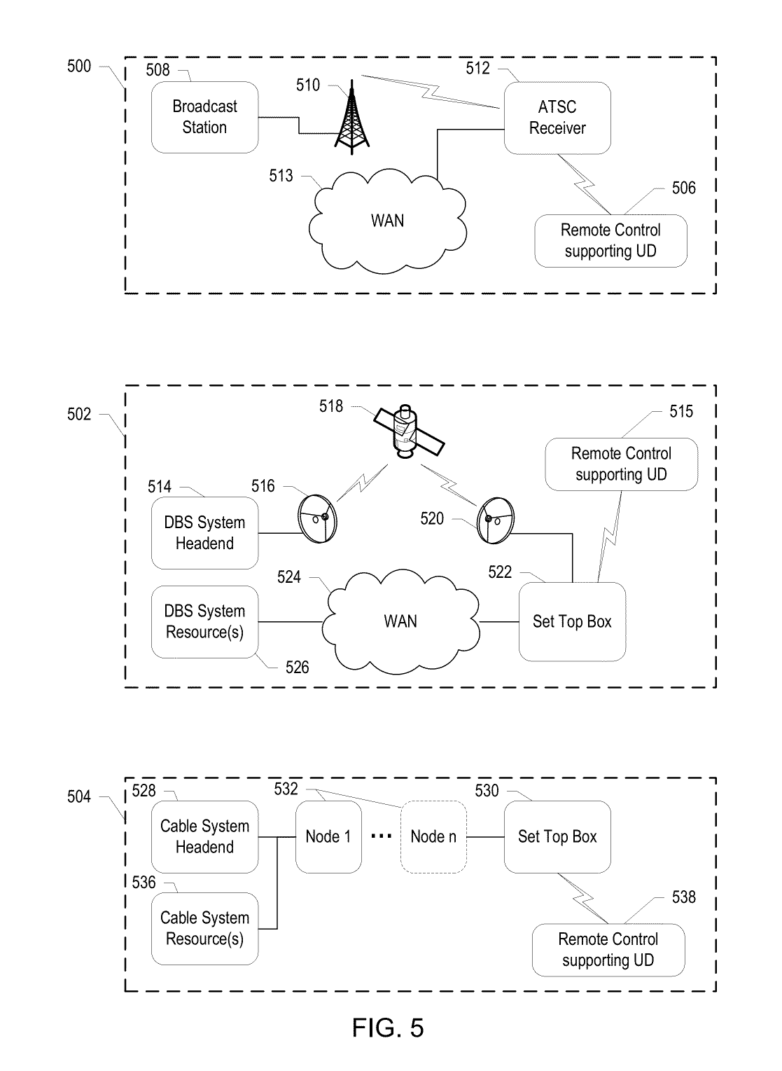

FIG. 5 illustrates three example environments 500, 502, 504 of a remote control supporting user determination. The example environment 500 illustrates a terrestrial television broadcast system having a remote control supporting user determination 506 that controls the ATSC receiver 512. The ATSC receiver can receive video signals from the broadcast station 508 transmitting through the antenna 510. In some implementations, the ATSC receiver 512 can communicate with resources accessible through the WAN 513. The remote control 506 can, for example, obtain user contact data from a user holding the remote control 506. A user determination system 200 can be implemented in one, some, or all of remote control resources, ATSC receiver resources, and network resources accessible over the WAN 513.

The example environment 502 illustrates a direct broadcast satellite (DBS) television system having a remote control supporting user determination 515 that controls the set top box 522. The set top box 522 can receive video signals from the DBS system headend 514 transmitted through the antenna 516 to the earth orbiting satellite 518, and received at the antenna 520. In some implementations, the set top box 522 can communicate with DBS system resources 526 accessible through the WAN 524. The remote control 515 can, for example, obtain user contact data from a user holding the remote control 515. A user determination system 200 can be implemented in one, some, or all of remote control resources, set top box resources, and DBS system resources 526.

The example environment 504 illustrates a cable television system having a remote control supporting user determination 538 that controls the set top box 530. The set top box 530 can receive video signals from the cable system headend 528 transmitted through one or more cable system nodes 532. In some implementations, the set top box 530 can communicate with cable system resources 536 accessible through the cable system network (e.g., using frequencies on the network reserved for two-way communication). The remote control 538 can, for example, obtain user contact data from a user holding the remote control 538. A user determination system 200 can be implemented in one, some, or all of remote control resources, set top box resources, and cable system resources 536.

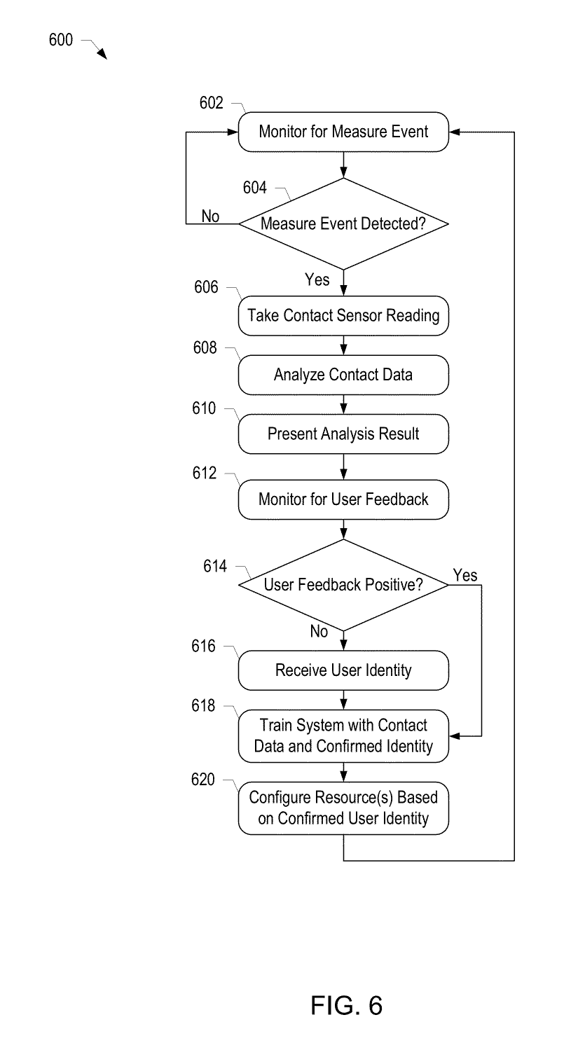

FIG. 6 is a flowchart of an example method 600 for determining user identity. At block 602 the method monitors for the occurrence of a measure event. A measure event can include, for example, a user making contact with a contact device, a contact device sensor (e.g., a vibration sensor or accelerometer) detecting that a contact device has been moved and/or moved to a certain orientation, a contact device button being pressed (e.g., a power button or other button on a remote control), contact sensors measuring a threshold value for galvanic response, contact sensors measuring a threshold value for capacitive response, and any combination of these events.

At decision block 604, if a measure event has not been detected, the method returns to block 602 to continue monitoring for a measure event. If a measure event is detected, the method proceeds to block 606.

At block 606 a contact sensor reading is taken. For example, data collected from capacitive sensors and/or galvanic sensors of a contact device can be read and captured. In some implementations, sensors can be read in parallel. In some implementations, contact sensors can be read using a multiplexing technique where, for example, sensors are read in series until sensor data has been collected from all sensors used in a given implementation. The sensed contact data can be stored in computer readable memory.

At block 608 the contact data is analyzed. For example, the sensed contact data can be compared to stored contact data to determine a best match between the sensed data and previously stored contact data associated with user identifiers of two or more known users.

At block 610, the result of the analysis is presented. For example, in some implementations, the name of an identified user can be shown on a display. In some implementations, operation of a device such as a contact device (e.g., a remote control) or network interface device (e.g., a set top box) can be configured according to user preference associated with the identified user can (e.g., a favorite channels list, or a color scheme for a user interface menu).

At block 612, the system monitors a user interface for user feedback. For example, through a user interface a user can expressly indicate that the identified user is correct or incorrect. In some implementations, a user interface can prompt a user for feedback. In some implementations, continued use of a contact device by a user without the user expressly indicating that the identified user is incorrect is treated as positive feedback.

At decision block 614, if the user feedback is positive the method proceeds to block 620. If the user feedback is negative, the method proceeds to block 616.

At block 616, a user indicated user identity is received as feedback. For example, after being presented with the analysis result, the user can indicate an alternative user identity for which there is already corresponding stored contact data or a new user identity can be provided (for a user that has no stored contact data). In some implementations, a user changing of a user interface parameter from one set at block 610 to an alternative user interface parameter associated with a different user is treated as user feedback. In such implementations, selection of the alternative user interface parameter is treated as feedback that the identified user is incorrect and that the user associated with the alternative user interface parameter is the correct user. For example, if a user changes list of favorite television channels in a television set top box user interface from one set at block 610 to an alternative list associated than that set at block 610, this is treated as if the user identity of the second user has been indicated.

At block 618, the user identity received at block 616 (or positively confirmed earlier from decision block 614) is used as the confirmed identity of the user from which the sensed contact data was obtained. This user identity and the sensed contact data is used to train a user determination system for use in later analyses.

At block 620, one or more resources can be configured based on the confirmed user identity. For example, a set of favorite channels, a user interface theme, and/or any other user preferences can be set according to stored user preferences associated with the confirmed user identity.

In some implementations, the example method 600 is performed in a user determination system having a relatively small user population. For example, a user determination system including a television remote control contact device can have a user population of four corresponding to four family members in a household. A user population can have a limited size where a contact device is shared solely or primarily among members of the same household or among friends. In some implementations, the example method 600 can be implemented in a user determination system where absolute accuracy in user identification is non-critical and errors in initial accuracy are permissible. For example, where a user determination system includes a television remote control, the loading of user preferences for an incorrectly identified user is often not a critical problem. Some error in determination of user identity can be acceptable in a user determination system where trust exists between members of the user population and/or where members find the potential disclosure of any saved user information to some other member to be acceptable.

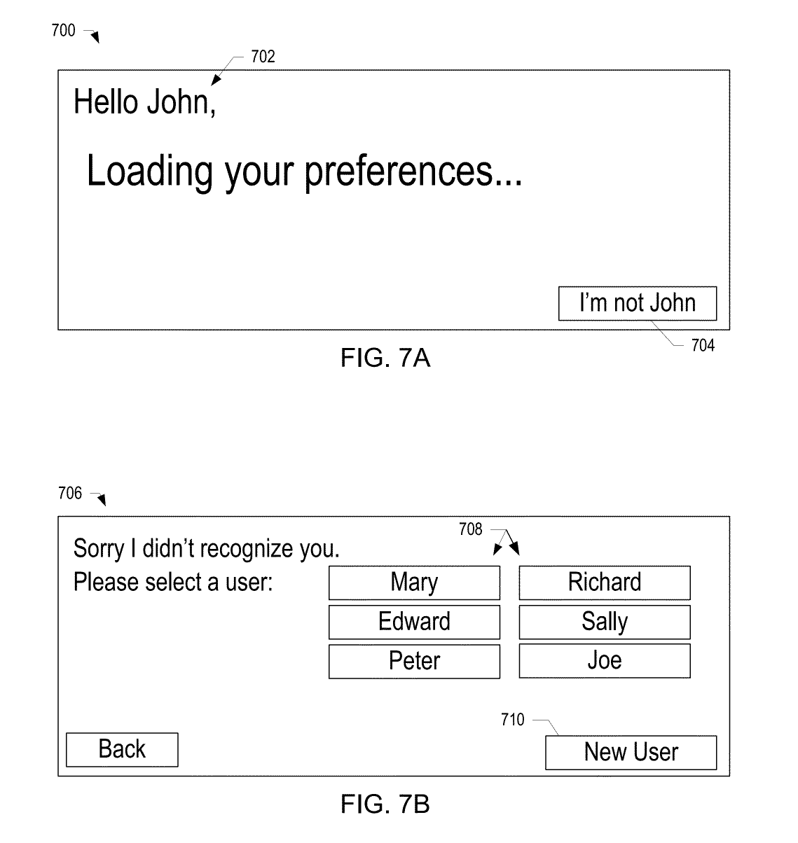

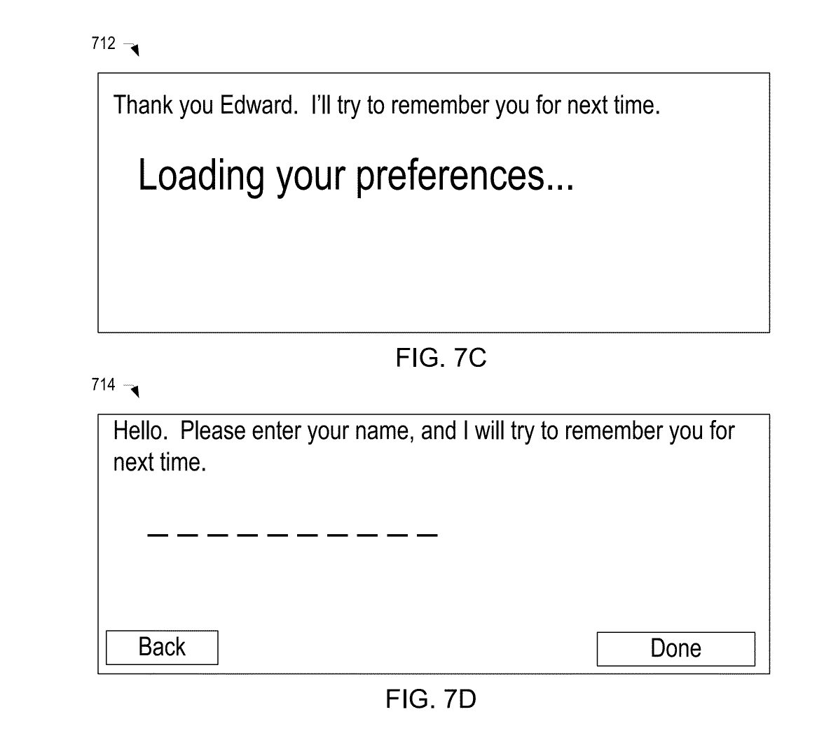

FIGS. 7A-7D illustrate various example user determination system interface screens. The example user interface screens can be displayed to a user making contact with a contact device. For example, the example screens can be shown on the display 104 of the example contact device 100 shown in FIG. 1. A user can make selections on the example screens by, for example, pressing control keys on a contact device such as directional keys, and an enter keys.

FIG. 7A illustrates an example user interface screen 700 including an indication of an identified user. The example screen 700 can be displayed to a user following a user determination analysis where sensed contact data has been read from contact sensors and compared to stored user contact data to identify a nearest match. The indication 702 informs the user that the name of the identified user is John. The user can highlight and select the “I'm not John” button 704 to provide feedback to a user determination system that the result of the analysis is incorrect.

FIG. 7B illustrates an example user interface screen 706 providing a user with the opportunity to indicate a correct user identity. The user can select one of the buttons 708 to indicate that the user is actually one of the other users that have user data stored in the user determination system. If the user is a new user of the system, the “New User” button 710 can be selected.

FIG. 7C illustrates an example user interface screen 712 acknowledging a user indicated identity. This screen can be shown, for example, following a user's selection of the “Edward” button shown in FIG. 7B.

FIG. 7D illustrates an example user interface screen 714 providing a new user with the opportunity to enter a new user name into a user determination system. This screen can be shown, for example, following a user's selection of the “New User” button 710 shown in FIG. 7B.

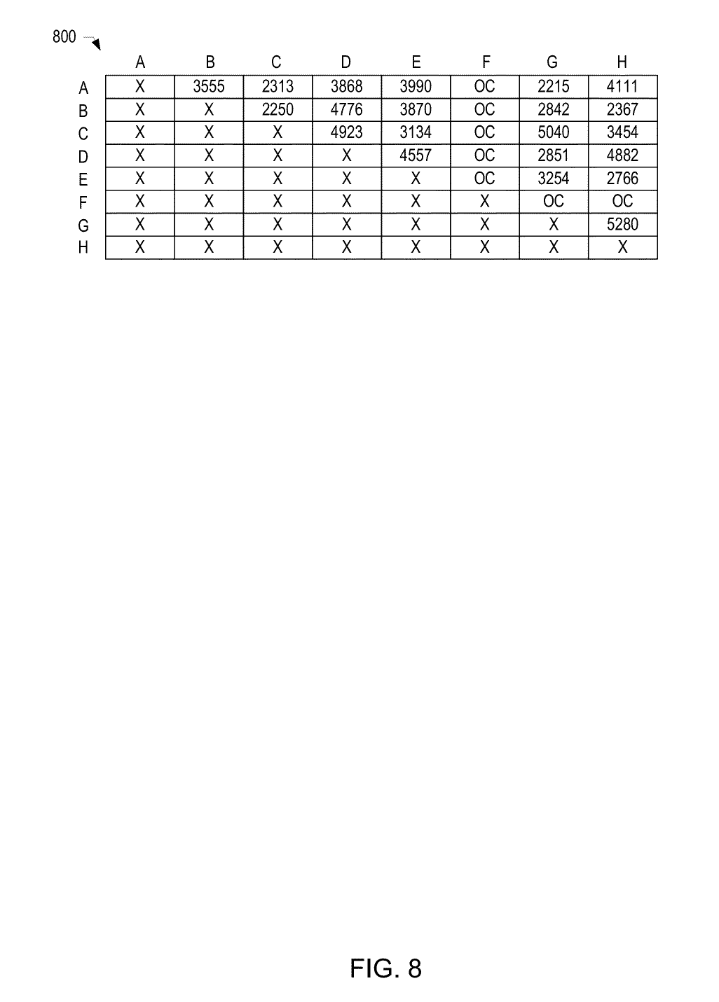

FIG. 8 shows a table 800 including example user contact data. The example data in the table 800 corresponds to an example measurement of galvanic skin response of a user holding the example contact device 100 of FIG. 1. The values can represent, for example, the resistance of a user's skin in kilo-ohms measured from a first contact indicated by the row designation on the left of the table 800 to a second contact indicated by the column designation along the top of the table 800. Null measurements from one contact to itself are indicated with an ‘X’ as are measurements already recorded at some other location in the table 800. The designation “OC” indicates an open circuit where the resistance value is high and out of range of the measurement being made. This can indicate, for example, that the user's hand is not making contact with one or both of the contacts for the given measurement. In the example shown, the user's hand is not contacting sensor contact F (e.g., sensor contact 102F in FIG. 1).

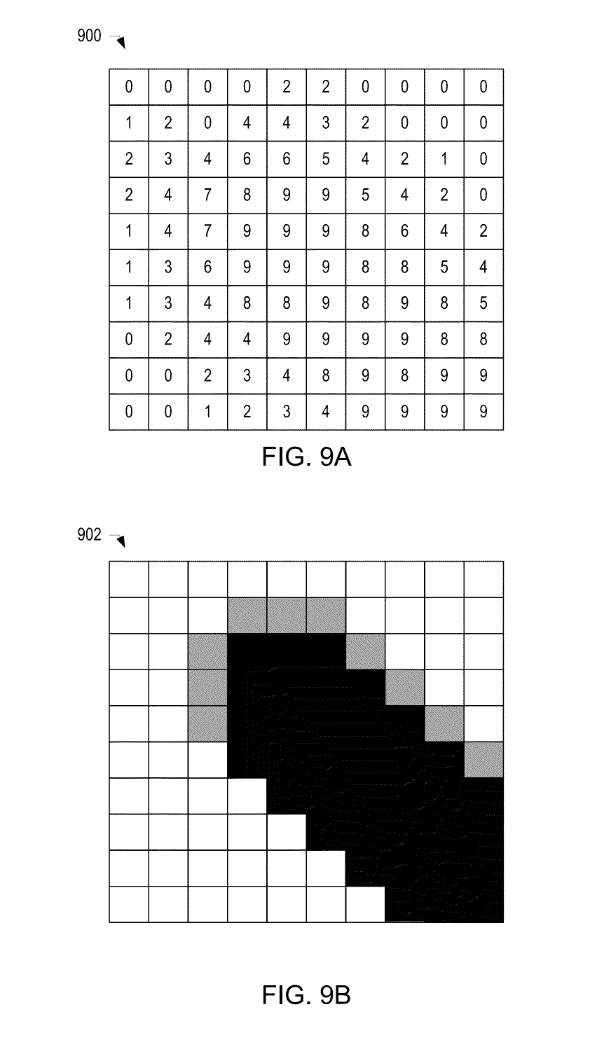

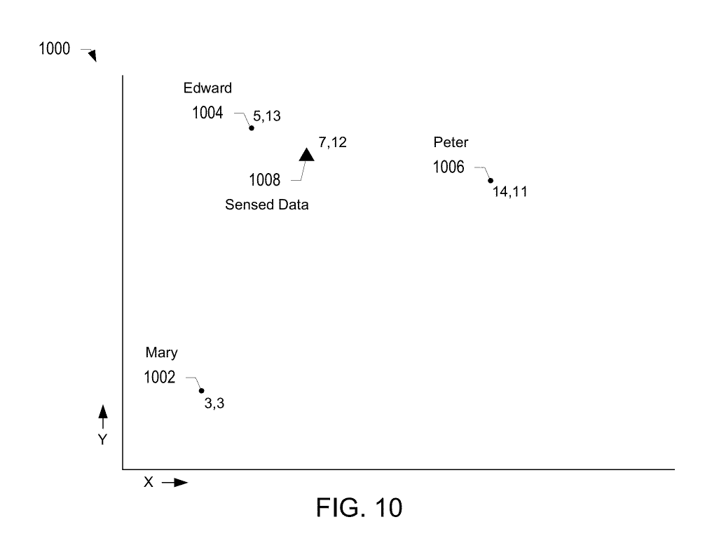

FIG. 9A shows a table 900 including example user contact data from capacitive touch sensors. The columns and rows of the table can, for example, correspond to a relative position of the corresponding capacitive sensor on the surface of a contact device. The value in each table position indicates a relative change in the capacitance of a circuit including the capacitive touch sensor from a state where a contact device is not being held, to a state where the contact device is being grasped by a human hand.

FIG. 9B shows a graphical representation 902 of the data of FIG. 9A. In the graphical representation 902, values of 8-9 are black, values of 5-7 are shaded gray, and values of 0-4 are white. The data can represent, for example, the tip of a user's finger. FIGS. 9A and 9B are given as examples. In some implementations, the arrangement of capacitive sensors can be distributed more diffusely across a contact device, more densely, and the size of each sensor can be larger or smaller. For example, a single large capacitive sensor can cover substantially all of the surface area of a contact device. In such implementations, the data of FIGS. 9A and 9B could be reduced to a single value.

To differentiate among members of a user population, a resolution of the measurement can be increased from the 10 possible capacitance values shown in FIG. 9A to as many as needed to achieve an acceptable level of user determination accuracy for an expected maximum user population size. Similarly, the number, size, and type, and sampling rate of contact device sensors can be selected according to an acceptable level of user determination accuracy for an expected maximum user population size. The cost and complexity of a user contact device and/or a user determination system can be decreased where a lower level of accuracy is acceptable and/or a maximum expected user population size is low.

Data such as that shown in FIGS. 8, 9A, and 9B can be saved in computer readable memory of contact device resources, network resources, and/or interface device resources. Data can be saved in a manner associating a given measurement with a user to which that measurement corresponds. In some implementations, a user determination system includes some or all of an ambient temperature sensor, a clock, and a calendar. Sensed contact data can be stored along with any or all of a measured ambient temperature, a time, and a date. Sensed contact data can be affected by the ambient temperature (e.g., due to perspiration), time of day (e.g., moisture content in a user's skin can change throughout the day), and the date (e.g., a user can wear less/thinner or more/thicker clothing depending on the season).

Upon a measure event being detected (e.g., user contact with a contact device is sensed) contact sensor readings can be made and the resulting measurement can be compared to the stored user data for a nearest match. In some implementations, for example, those including only a single resistance sensor or capacitance sensor, a match can be defined as sensed contact data within some percent of a previous reading stored in user contact data. In some implementations, a user response curve can be measured where resistance and/or capacitive readings are taken over a period of time that a user is in contact with a contact device. For example, readings can be taken during a period in which a user is holding a remote control. A set of sensor readings as a function of time during this period are referred to below as a response curve. In some implementations, a maximum, minimum, and average value can be computed for each possible sensor reading during this period. Those values can be stored in the user contact data and later compared to corresponding values measured while some unknown user is holding the remote control to identify that user. In some implementations, response curves stored user data and a response curve for currently sensed data is compared according to a least squared distance analysis to determinate a nearest match.

In some implementations, determined user identity is used to provide, for example, some or all of targeted television advertisements, data for use in a television ratings system, and user content recommendations.

In some implementations, the user determination system is configured to interface with one or more external systems to share a determined user identity. For example, a user determination system can be configured to interface with an aforementioned television ratings system. Any sharing of data with external systems can be limited to data previously authorized by a user for sharing and/or data that has been appropriately anonymized to protect a user's privacy. For example, user specific data sent to a television ratings system can be limited to a user's age group (e.g, 18-35), gender (e.g., male), a program watched, and time the program was watched. In some implementations, a user determination system can be configured to interface with a television advertisement delivery system so that targeted advertisements are provided to the user during commercial breaks, overlaid on a program being watched, or otherwise added to a television viewing session. In some implementations, a user determination system can be configured to interface with a television content delivery system so that program recommendations can be provided to a user, and/or user specific content can be provided (e.g., an alternate ending can be provided to a user based on their identity, or user objectionable material can be removed from a program). In some implementations, an interface between the user determination system and one or more external systems is facilitated through an application programming interface (API). In some implementations, the API can provide access to a determined user identity. In some implementations, the API can provide access to stored user data and/or sensed user data such that an external system can access user preferences and/or perform its own user determination analysis.

FIG. 10 shows a graphical representation 1000 of an example user determination based on comparison of sensed user data to stored user data. In the example shown, stored sensor data and/or data derived from stored sensor data is shown at points 1002, 1004, and 1006 plotted on a two dimensional coordinate system. Point 1002 is associated with the user Mary. Point 1004 is associated with the user Edward, and point 1006 is associated with the user Peter. The each axis of the graph represents a value from a corresponding sensor. For example, the X-axis can represent an impedance in mega ohms measured at a first sensor, and the Y-axis can represent an impedance in mega ohms measured at a second sensor. The values given are for example only and are simplified to whole numbers for purposes of explanation. The location of the points 1002, 1004, and 1006 can represent, for example, the centroid (or average or mean) of all stored data corresponding to a given user.

The triangle 1008 represents a current set of sensed data measured at a contact device. The sum of the squares of the differences between point 1008 and each of points 1002, 1004, and 1006 can be computed. For example, point 1002 and point 1008 are 4 x-units and 9 y-units apart. The sum of the squares (4²+9²) is 97. This result for point 1004 (2²+1²) is 5 and for point 1006 (7²+1²) is 50. The least of this set of sums of the squares is 5 which corresponds to the stored user data for the user Edward. Based on this comparison, the contact device can provide an indication that the user Edward has been identified.

In the example provided, the comparison is made with the number of sensed values, n, being 2. The example can, however, be expanded to apply to any number of sensed values. E.g., the sum of the squares can be computer for any number of sensed values can be computed to determine a match between sensed contact data and stored contact data to identify a user.

In some implementations, after the determined user identity has been confirmed (e.g., directly through a user press confirming the identity or indirectly after continued use of the contact device without providing an indication that the determined user identity is incorrect) the new value can be added to the stored data set for the determined user. For example, in the example above, the point 1008 can be added to and averaged into the data corresponding to the point 1004. This can, for example, move the centroid for the user Edward closer to the point 1008. In some implementations, the points 1002, 1004, and 1006 are not simply centroids of previously stored sensor data but are locations computed through various weightings of previous stored measurements. For example, a date that a given measurement was made, e.g., for the user Edward, can be used to age that measurement such that its effect on the location of the point 1004 used to compute the sum of the squares of the difference is lessened as that sample ages.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, that is generated to encode information for transmission to suitable receiver apparatus for execution by a computer. The computer-readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, computers can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a contact device including at least one contact sensor for reading at least one electrical characteristic of user contact with the contact device;
one or more processors; and
computer readable medium including instructions executable by the one or more processors and upon execution cause the one or more processors to perform operations comprising:
determining a user identity based on a comparison of the at least one electrical characteristic to stored user data;
providing an indication of the determined user identity;
receiving user feedback regarding the determined user identity; and
setting an aspect of system operation based on the user feedback.

2. The system of claim 1, wherein providing an indication of the determined user identity comprises displaying a name associated with the identified user.

3. The system of claim 1, wherein providing an indication of the determined user identity comprises configuring the system with one or more user preferences associated with the identified user.

4. The system of claim 1, wherein receiving user feedback comprises receiving an indication that the identified user is incorrect.

5. The system of claim 1, wherein receiving user feedback comprises receiving an indication that the identified user is correct.

6. The system of claim 5, wherein receiving an indication that the identified user is correct comprises detecting use of the contact device after the indication of the determined user identity is provided without receiving an indication that the identified user is incorrect.

7. The system of claim 1, wherein setting an aspect of system operation based on the user feedback comprises configuring the system with one or more user preferences associated with a user identity indicated by the user feedback.

8. The system of claim 1, wherein setting an aspect of system operation based on the user feedback comprises training the system to adjust future user determinations based on the user feedback.

9. The system of claim 1, wherein determining a user identity based on a comparison of the at least one electrical characteristic to stored user data comprises comparing a response curve of the at least one electrical characteristic to two or more stored response curves associated with respective users.

10. The system of claim 1, wherein the at least one electrical characteristic includes a resistance measurement of human skin in contact with the contact device.

11. The system of claim 1, wherein the at least one electrical characteristic includes a capacitance measurement of a circuit having a capacitance affected by a human body proximate to the contact device.

12. The system of claim 1, wherein the contact device comprises at least two conductive sensor contacts for measuring resistance of human skin.

13. The system of claim 1, wherein the contact device comprises at least one capacitance sensor for measuring the capacitance of a circuit having a capacitance affected by a human body proximate to the contact device.

14. The system of claim 1, wherein the contact device comprises:
at least two conductive sensor contacts for measuring resistance of human skin; and
at least one capacitance sensor for measuring the capacitance of a circuit having a capacitance affected by a human body proximate to the contact device.

15. The system of claim 1, wherein the contact device is a remote control for selecting a television program.

16. The system of claim 1, wherein setting an aspect of system operation based on the user feedback comprises displaying targeted video content.

17. The system of claim 16, wherein the targeted video content is an advertisement selected from a group of potential advertisements.

18. The system of claim 1, wherein setting an aspect of system operation based on the user feedback comprises displaying recommended video content.

19. A method comprising:
determining a user identity based on a comparison of stored user data to at least one electrical characteristic read at a sensor of a user contact device;
providing an indication of the determined user identity;
receiving user feedback regarding the determined user identity; and
setting an aspect of system operation based on the user feedback.

20. A system comprising:
means for measuring contact;
one or more processors; and
computer readable medium including instructions executable by the one or more processors and upon execution cause the one or more processors to perform operations comprising:
determining a user identity based on a comparison of the at least one electrical characteristic to stored user data;
providing an indication of the determined user identity;
receiving user feedback regarding the determined user identity; and
setting an aspect of system operation based on the user feedback.
